(19) United States
(12) Patent Application Publication
(10) Pub. No.: US 2017/0316048 A1
(43) Pub. Date: Nov. 2, 2017

(54) METHOD AND SYSTEM FOR FILTERING DATA SERIES

(71) Applicant: NEC Europe Ltd., Heidelberg (DE)

(72) Inventors: Apostolos Papageorgiou, Heidelberg (DE); Bin Cheng, Eppelheim (DE); Ernoe Kovacs, Stuttgart (DE)

(21) Appl. No.: 15/533,664

(22) PCT Filed: Dec. 8, 2014
(86) PCT No.: PCT/EP2014/076899

§ 371 Date: Jun. 7, 2017

(51) Int. Cl. G06F 17/30

(52) U.S. Cl. CPC G06F 17/30371

(57) ABSTRACT

A method for filtering data series includes filtering, by filtering entities, the data series by: collecting a data series including original information; reducing the original information of the data series based on and by at least one data reduction procedure to produce at least one set of reduced information of the data series; reconstructing the original information for the at least one set of reduced information of the data series; calculating a level of reconstruction for the reconstructed information based on a comparison between the reconstructed information and the original information for the at least one data reduction procedure; and determining reduced or non-reduced information of the data series to be forwarded based on a comparison between a desired level of reconstruction and the calculated level of reconstruction.

### CROSS REFERENCE TO RELATED APPLICATIONS

This application is a U.S. National Stage Application under 35 U.S.C. §371 of International Application No. PCT/EP2014/076899 filed on Dec. 8, 2014. The International Application was published in English on Jun. 16, 2016 as WO 2016/091278 A1 under PCT Article 21(2).

### FIELD

The present invention relates to a method for filtering data series, preferably time series of data, prior to further processing. The present invention further relates to a system for filtering data series, preferably time series of data, prior to further processing.

### BACKGROUND

In internet-of-things or machine-to-machine systems, devices conventionally send or actuate or any other automated data-generating task constantly provide information about any object, also called “thing”, mostly in form of so-called time series. Time series usually refer to data that are generated and/or collected at successive times in regular or irregular intervals and comprise a key-value pair. For example the value is a simple data type, for instance numeric, alphanumeric or binary data and a corresponding timestamp. For example time series stemming from internet-of-thing devices are one of the enablers of the so-called big data.

Time series collected by internet-of-things devices are often forwarded and stored via deployments based on a system illustrated in FIG. 1. For instance the data provided by M2M devices D goes either via a cellular network or via proxies like edge routers or gateway devices GW and through a backbone network NC to a backend system BS storing, processing and offering related information for example with a common application programming interface API to applications of various domains.

Conventionally the data is forwarded and stored in a data center DC, for example a cloud. However, this causes a plurality of problems: For instance one of the problems is the bandwidth consumption and/or latency between the data delivering devices D or the gateways GW and the network core NC or the data center DC respectively. The further problems are the storage costs and the database performance of a data center DC. Another problem is the energy consumption on various tiers and further the system resilience because of potential concurrent database transactions. With the increasing use of the internet-of-things these problems will become even bigger in the future.

To address these problems the non-patent literature of Tak-chung Fu, “A review on time series data mining”, Engineering Applications of Artificial Intelligence, Volume 24, Issue 1, February 2011, Pages 164-181, ISSN 0952-1976 and of W. Lang, M. Morse, and J. M. Patel, “Dictionary-Based Compression for Long Time-Series Similarity,” IEEE Transactions on Knowledge and Data Engineering, vol. 22, no. 11, pp. 1609-1622, November, 2010 apply conventional reduction procedures like sampling, compression and/or selected forwarding, for example rule based and/or application-specific, or are customized for conventional internet-of-thing architectures such as for example shown in FIG. 1 or for important internet-of-things application domains such as transportation, industrial automation, safety, etc.

In the further non-patent literature of J. Zhang, K. Yang, L. Xiang, Y. Luo, B. Xiong, and Q. Tang, “A Self-Adaptive Regression-Based Multivariate Data Compression Scheme with Error Bound in Wireless Sensor Networks”, International Journal of Distributed Sensor Networks, Vol. 2013, Article ID 913497 a method is shown for deciding automatically to transmit either raw or regression coefficients and in the latter case to select the number of data involved in the regressions.

However, these conventional methods act upon already collected data sets. Further they are often avoided because of the information loss that selected forwarding or data filtering inherently applies.

In FIG. 1 this effect is illustrated with different data reduction procedures F1, F2, F3 applied on the original collected data series O-TS. For example when on the original time series with data collected in period T2 the data reduction method F1 is applied then the filtered data is completely lost, indicated by a non-present bar. The same is true for data reduction method F2. With data reduction method F3 a smaller amount of data is available afterwards. For the time series collected in period T4 the same is true for the data filtered with the data reduction procedure F1 and with the sampling according to data reduction mechanism F2 whereas when compression F3 is applied on the data collected in period T4 the compression has no effect, indicated by a non-changed bar in FIG. 1.

These information “losses” are very difficult to determine, especially when designing a data-agnostic system, i.e. a system that cannot filter based on the semantics of the data or based on application-specific needs. One reason for example is that it is unknown who will use the data and in which way.

### SUMMARY

In an embodiment, the present invention provides a method for filtering data series, preferably time series of data, prior to further processing, wherein the data series are collected by collecting entities and provided to one or more filtering entities from one or more data delivering devices, and wherein the filtered data series are forwarded to further processing entities. The method includes filtering, by the filtering entities, the data series by the following steps: collecting a data series including original information; reducing the original information of the data series based on and by at least one data reduction procedure to produce at least one set of reduced information of the data series; reconstructing the original information for the at least one set of reduced information of the data series; calculating a level of reconstruction for the reconstructed information based on a comparison between the reconstructed information and the original information for the at least one data reduction procedure; and determining reduced or non-reduced information of the data series to be forwarded based on a comparison between a desired level of reconstruction and the calculated level of reconstruction.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a conventional internet-of-thing deployment;

FIG. 2 shows a part of a system according to a first embodiment of the present invention;

FIG. 3 shows a part of a method according to a second embodiment of the present invention;

FIG. 4 shows a part of a system according to a third embodiment of the present invention;

FIG. 5 shows a part of a method according to a fourth embodiment of the present invention; and

FIG. 6 shows a part of a system according to a fifth embodiment of the present invention.

### DETAILED DESCRIPTION

A method and a system are described herein for filtering data series with enhanced efficiency in terms of storage, bandwidth and averaged data quality preferably in an internet-of-things or machine-to-machine systems.

A method and a system are described herein for filtering data series which can maintain the desired level for the reconstructability of the original data from a subset that has been forwarded and/or stored in a data center.

A method and a system are described herein for filtering data series that enhance control of the degree of information “loss” due to filtering independent of which filtering method is being applied.

Although applicable to any kind of systems, the present invention will be described with regard to data series in connection with the internet-of-things or machine-to-machine systems.

Although applicable in general to any type of data series, the present invention will be described with regard to time series of data.

In an embodiment, a method for filtering data series, preferably time series of data, prior to further processing, wherein the data series are collected by collecting entities and provided to one or more filtering entities from one or more data delivering devices, and wherein the filtered data series are forwarded to further processing entities is defined. The method is characterized in that the filtering by the filtering entities is performed by the steps of:
a) Collecting a data series,
b) Reducing the information of the data series based on and by at least one data reduction procedures,
c) Reconstruction of the original information for each reduced information of a data series,
d) Calculating the level of reconstruction for the information based on a comparison between the reconstructed information and the original information collected in step a) for at least one of the reduction procedures, and
e) Determining the reduced or non-reduced information of the data series to be forwarded based on a comparison between a desired level and the calculated level of reconstruction.

In an embodiment a system for filtering data series, preferably time series of data, prior to further processing, comprising one or more data delivering devices adapted to provide data series, one or more collecting entities adapted to collect said data series and to provide them to one or more filtering entities and wherein said one or more filtering entities are adapted to forward the filtered data series to further processing entities is defined. The system is characterized in that said one or more filtering entities are adapted to perform the steps of:
a) Collecting a data series,
b) Reducing the information of the data series based on and by at least one data reduction procedures,
c) Reconstruction of the original information for each reduced information of a data series,
d) Calculating the level of reconstruction for the information based on a comparison between the reconstructed information and the original information collected in step a) for at least one of the reduction procedures, and
e) Determining the reduced or non-reduced information of the data series to be forwarded based on a comparison between a desired level and the calculated level of reconstruction.

The term “reconstructability” can be understood as a degree to which an original data set can be reproduced from a reduced instance of the data set, preferably the original data set with missing points or values, the function that can be used to retrieve points of the data set, or a different data set that has been generated from a transformation of the original data set. It is preferably expressed as a percentage, based on system-specific matrix, etc.

The term “gateway” can be understood in its broadest sense, in particular as an entity at a network edge.

The term “entity” can be understood in its broadest sense, in particular an entity like a filtering entity can preferably also act as further processing entity and/or act as entity of another type, etc.

According to methods and systems described herein, it can be easily determined which data to forward, which to filter and which to cache based on a reconstructability of the data series, preferably of data points of time series.

According to methods and systems described herein, the efficiency in terms of storage, bandwidth and average data quality is enhanced, while simultaneously maintaining a predefined level for the reconstructability of the original data from the subset that has been stored, for example in a data center.

According to methods and systems described herein, filtering or compression techniques for time series can preferably applied before actually collecting and are replied upon preferably frontend samples.

According to methods and systems described herein, by using reconstructability levels, settings of the data reduction procedures can be translated into degrees of information loss.

According to methods and systems described herein, knowledge about the reconstructability of the data series can be related with decisions about settings of used data reduction procedures.

According to methods and systems described herein, data-agnostic data filtering with controlled degree of information loss can be enabled.

According to methods and systems described herein, a translation of settings of data reduction procedures into degrees of expected information losses can be provided. Further methods and systems described herein can relate the knowledge about reconstructability of data with decisions about settings of the used data reduction procedures. Further, methods and systems described herein can enable data agnostic data filtering with a controlled degree of information loss.

According to a preferred embodiment at least steps a)-d) are performed in irregular and/or regular time intervals, upon prespecified changes and/or appearance of prespecified values in data series. This enables in a simple and efficient way to trigger filtering and the analysis of incoming data series: When and how frequently the data is being (re)examined is determined. A simple timer may trigger the analysis in regular or irregular intervals. An event detector may trigger the analysis upon detection that certain prespecified values of the data series are changing and/or are exceeded a certain prespecified threshold. Another possibility is that the event detector may trigger the analysis upon appearance of certain prespecified values in the information of the data series that indicate a change of behavior. Of course any other procedure may alternatively or additionally be used.

According to a further preferred embodiment when collecting the data series the highest possible polling rate and/or the highest possible resolution is used. This enables to provide most actual and/or most precise data when collecting the data series, for example based on the available bandwidth of the communication between the data delivering devices and the filtering entities. Further precision of the reduction procedures is enhanced since the largest possible amount of data for later analysis can be used.

According to a further preferred embodiment reconstructability information is generated specifying for each data series and for each reduction procedure and for corresponding input values for said reduction procedures a value for the level of reconstruction. This enhances the flexibility to a great extent which reduced data shall be forwarded for further processing to the further processing entities.

According to a further preferred embodiment the reconstructability information are updated when steps a)-d) are performed. This enables providing most actual reconstructability information for deciding which data to be forwarded in what way.

According to a further preferred embodiment a reduction procedure is provided in form of a procedure reducing dimensionality and/or size of the data series and/or a generation of a function representing the data series. Dimensionality reduction is for example provided in sampling of each, every second, every fourth or no data point of a data series. Function-based representation of a reduction procedure, for example forwards only a function which represents the data “as good as possible”, for example only every second data point is used and a spline function is generated through every second data point and the function of said spline together with the corresponding data interval is forwarded for further processes providing efficient reduction procedures. Of course any other data reduction procedure can be used additionally or alternatively. Also applying of different reduction procedures sequentially is possible.

According to a further preferred embodiment the comparison according to step d) is performed on a similarity metric, preferably using Euclidian distance. This enables in a fast and efficient way to provide a comparison between the reconstructed information and the original information.

According to a further preferred embodiment the collecting entities are configured based on the operational status of said filtering entities. This enhances the flexibility while providing an optimum of communication between the filtering entities and the collecting entities.

According to a further preferred embodiment when the operational status of the filtering entities is dedicated for energy saving then the collecting entities are reconfigured such that only reduced information satisfying the desired level of reconstruction is collected. “Reduced” means here as much as needed to satisfy the reconstructability degree that has been requested. This reduces the collecting entity traffic and saves energy of the collecting entity.

According to a further preferred embodiment when the operational status of the filtering entities is dedicated for network resource saving then the collecting entities are reconfigured such that only reduced information satisfying the desired level of reconstruction are forwarded and preferably the collected information is cached in the filtering entity and/or in the collecting entity. This releases the network and storage demand equally to the reconfiguration of the collecting entities for energy saving and keeps more collected data in the cache which might be retrieved later. Therefore, the flexibility is further enhanced since data in the cache can be provided at any time if needed.

According to a further preferred embodiment when the operational status of the filtering entities is dedicated for network resource saving, the collected information are forwarded upon demand of the further processing entities in regular time intervals and/or never. “Upon demand” means that data can be eventually retrieved upon request. This preferably means that it may take time until the data is delivered for example to optimize bandwidth usage or because intermediate nodes are unreliable such that manual fetching of the data to the backend system is preferred. Another option is that big amounts of data will be sent at all to the backend system if not explicitly requested for instance. “In regular time interval” means that the data cached is copied, or i.e. transmitted to the backend system BS regularly with time intervals that are preferably much bigger than the data capture intervals. If they are forwarded never then the data series cached can only be used locally and might be dropped at any time.

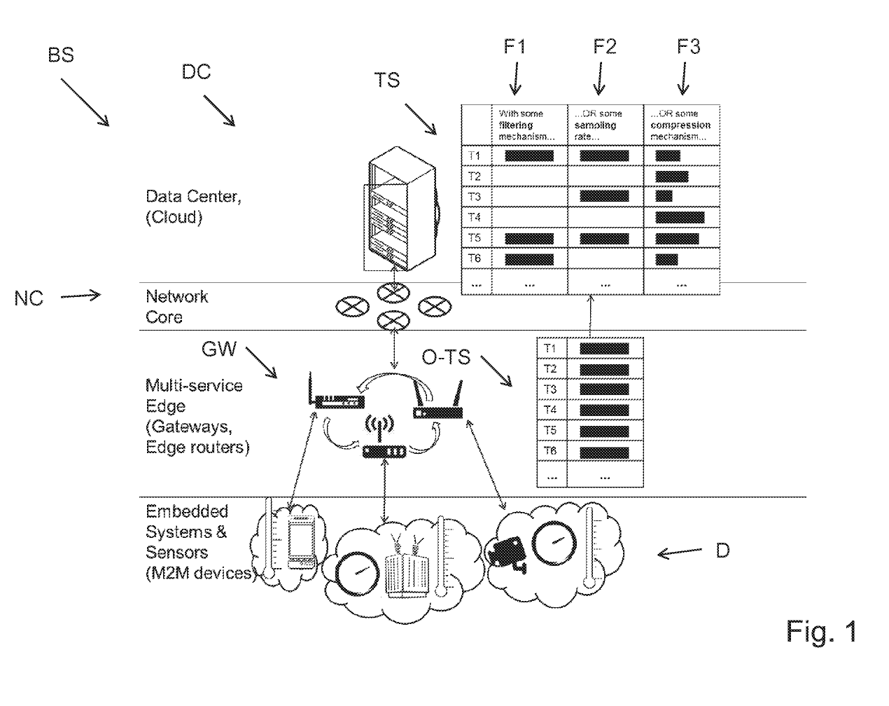

FIG. 1 shows a conventional internet-of-thing deployment. In FIG. 1 time series for filtering in a conventional internet-of-thing deployment is shown. A number of embedded systems and sensors D is connected to a multi-service edge like gateways, edge routers or the like GW. These gateways GW collected data from the devices D which is illustrated by the table indicating as bars the data within the time periods T1, T2, T3 in original time series O-TS. The gateways GW are connected via a network core NC to a backend system BS comprising a data center DC. The gateways GW provide filtered data of the original time series O-TS which is depicted on the upper right corner of FIG. 1. The data within the periods T1, T2, T3 are then transmitted to the data center DC reduced with some filtering F1 procedure or some sampling rate F2 or some compression procedure F3. The bars in the table of the time series indicate the level or the amount of data after the data reduction procedure F1, F2, F3 has been applied. For example for the data series in period T1 and the filtering F1 the data series in period T1 of the original data series O-TS corresponds to the filtered one whereas for said original data series in period T1 on which the compression mechanism F3 has been applied smaller data was transmitted to the data center DC, as depicted in FIG. 1 with a smaller bar.

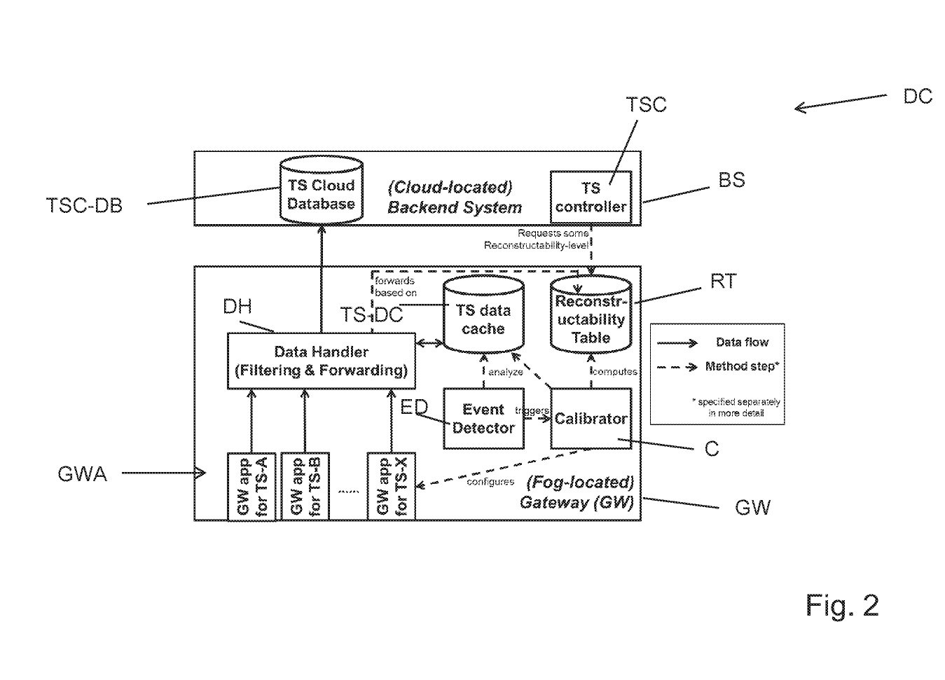

FIG. 2 shows a part of a system according to a first embodiment of the present invention. In FIG. 2 a system for the enablement of reconstructability-aware time series handling is shown. In FIG. 2 a gateway GW is shown comprising gateway applications GWA for different time series TS-A, TS-B, . . . , TS-X. These gateways applications GWA are connected to a data handler DH for filtering and forwarding of data series provided to the data handler DH by the gateway applications GWA. The data handler DH is further connected to a backend system BS to forward filtered data comprising a time series cloud database TSC-DB. Further the backend system BS comprises a time series controller TSC which requests some reconstructability level from a reconstructability table RT which is again located or stored in the gateway GW. Further the gateway GW comprises a time series data cache TS-DC, an event detector ED and a calibrator C. The event detector ED triggers the calibrator C to analyze the data and to update the reconstructability table RT. The data handler DH exchanges data with the time series data cache TS-DC. When the event detector ED triggers the calibrator C the calibrator C preferably configures the gateway applications GWA.

The above mentioned entities in the gateway GW and the backend system BS are in the following described in more detail:
Gateway application GWA: This entity may be preferably realized in form of a software module that communicates directly with the data source, i.e. with an M2M/IoT device D. The pattern of its interaction with the data source D can be configured by another module, but the Gateway Application GWA itself has no knowledge about the actual data reduction procedures.
Data Handler DH: This entity offers for example an API to the gateway applications GWA, through which the latter can report the data they receive from the data sources D. The data handler DH is then responsible for writing them back to the Cloud Database TSC-DB, to the local Cache TS-DC or both.
Time Series Data Cache TS-DC: This entity may be provided as a cache memory of the gateway GW which stores time series, if possible in exactly the same way they are stored in the Cloud database TSC-DB. The purpose of caching may be threefold: a) use cache data sets to measure the statistical characteristics of the data that are related to their reconstructability, and/or b) keep a copy of data that have not been stored in the Cloud, and/or c) keep (recent) data close to the data sources D for cases where fast or “offline” response/actuation is required. From the above, it is preferably “a)” that is directly related to the description of method steps that will follow.
Event Detector ED: This entity looks into the incoming/cached time series TS and determines if and when a statistical analysis of the data is required in order to adjust the reconstructability table RT, i.e. the knowledge base based on which the forwarding/filtering of the Data Handler DH is done. The Event Detector ED can operate in parallel with the Data Handler DH and independently of the data forwarding process. Its operation does not affect the flow of the actual data until a new reconstructability table RT has been calculated.
Calibrator C: This entity may be triggered by the Event Detector ED in order to do the analysis of the cached data and update the reconstructability table RT, as well as the configuration of the Gateway Applications GWA.
Reconstructability table RT: This entity is a knowledge base comprising all the information that the Data Handler DH needs in order to decide how to filter and forward data, e.g. maximum acceptable degree of information loss, mapping of data reduction procedures, settings to degrees of information loss, and more.
Time Series Controller TSC: This entity—among others—informs the gateway GW about the maximum acceptable degree of information loss.
Time Series Cloud Database TSC-DB: This is the Cloud Database where the time series data is stored.

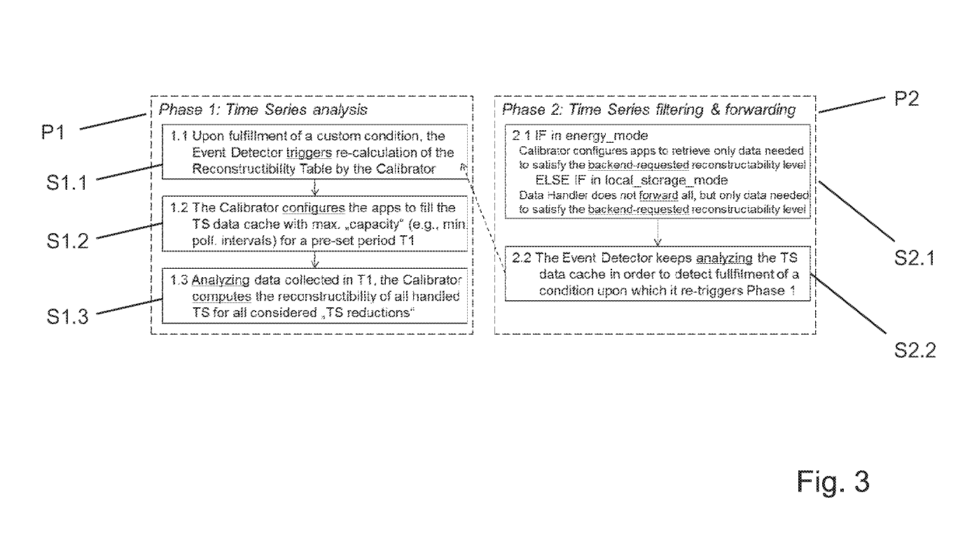

FIG. 3 shows a part of a method according to a second embodiment of the present invention. In FIG. 3 a high level flow of the reconstructability-aware time series forwarding and filtering procedure is shown. In a first phase P1 the time series is analyzed with steps S1.1-S1.3 and a second phase P2 filters and forwards the data with steps S2.1 and S2.2, wherein both phases P1, P2 may be at least partially performed in parallel. The steps are now described in more detail:

### Step S1.1

The Event Detector ED triggers an analysis of incoming time series, for example upon fulfillment of a custom condition. For triggering this, the Event Detector ED has a mechanism or procedure which determines when and how frequently the data is being re-examined in order to update the reconstructability table RT. This mechanism/procedure can be for example:
A simple timer, which triggers the analysis in regular or irregular intervals.
An event detector ED, which triggers the analysis upon the detection of the fact that the changes of certain (pre-specified) values of the time series are exceeding a certain (pre-specified) threshold.
An event detector ED, which triggers the analysis upon the appearance of certain (pre-specified) values in the Time Series data which commonly indicate a change of behavior and/or
Any mechanism similar to the above.

### Step S1.2

When the Calibrator C is triggered by the Event Detector ED (Step S1.1), then the following sub-steps are preferably performed:
The GW applications GWA that communicate with the devices/sensors D are reconfigured by the Calibrator C so that for the monitored time series they use the:
   Highest possible polling rates and/or
   Highest possible quality/resolution, if, e.g. media content is involved.
The GW applications GWA collect data with the above configuration for a period T1 and write it into the cache TS-DC
   The length of period T1 is pre-set or
   The length of period T1 is domain- and time series-dependent and is expected to vary, e.g. between a few seconds and various hours or even days.

### Step S1.3

Upon expiration of the time period T1, the Calibrator C uses the data collected during T1 to compute the reconstructability table RT.

### Step S2.1

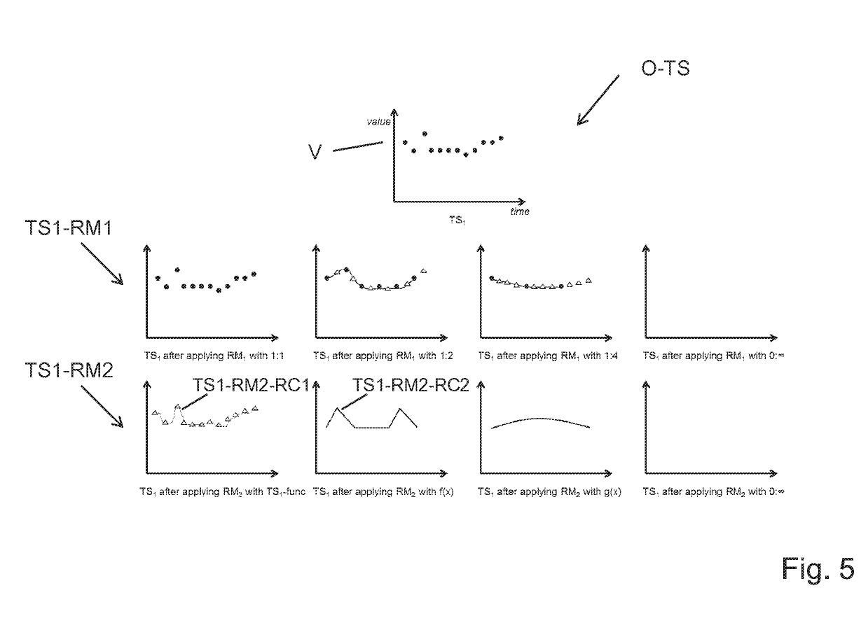

Once the reconstructability table RT has been computed, two options may be performed:
If the gateway GW has an “energy-saving-mode”, i.e. an operational state with reduced energy consumption, being activated then the Calibrator C re-configures the Gateway applications GWA to retrieve only the “reduced” data from the data sources. “Reduced” means as much as needed to satisfy the reconstructability degree that has been requested, e.g., in FIG. 5 when performing Step 1.3 half of the data points (i.e., use “1:2-dimensionality-reduction”) are sent if a reconstructability degree of 90% had been indicated as sufficient by the TS controller TSC. The indication of a “required reconstructability degree” by the TS controller TSC may be performed by any suitable means. It is assumed that the “reconstructability requirement” has been given by the TS controller TSC to the gateway GW asynchronously at some point before Phase P2.) This energy saving mode reduces device traffic and saves device energy, but captures less data.
If the the gateway GW has a “network-relieving-mode”, i.e. an operational state with reduced data transmission, being activated then the gateway GW applications GWA will continue retrieving data the same way as during the period T1, but the Data Handler DH will send only the “reduced” data to the backend BS and keep the rest only in the TS data cache TS-DC. This option can be more heavyweight for the devices, but relieves the network and storage demand equally to the first option and keeps more data in the cache TS-DC, which might be retrieved later. Given that this mode keeps all data points in the cache, the behavior of the cache must also be specified.

Therefore, the “network-relieving-mode” has preferably three sub-modes:
“on-demand”: The data points of the TS data cache TS-DC can be eventually retrieved upon request of the TS controller TSC. This means that it might take time until the data is delivered to the Cloud BS, e.g. to optimize bandwidth usage, or because the intermediate nodes are unreliable, so manual fetching of the data to the Cloud BS is preferred or that big amounts of data will not be sent at all to the Cloud BS, i.e., if not explicitly requested.
“regular-update”: This functions in essence like the “on-demand” option, but the TS data cache TS-DC is copied to the Cloud BS regularly, with time intervals that are typically much bigger than the data capture intervals, e.g., once a day. Thus, this sub-mode is preferably applied when cloud storage efficiency is not an issue because all data is stored there eventually and no guarantees about data availability and resilience are required, because the TS data cache TS-DC is less reliable than the Data Center for instance.
“never”: TS data cache TS-DC can be used only locally and might be dropped at any time.

In this case the gateway GW can be preferably operating either in the “energy-saving-mode” or in the “network-relieving-mode”.

### Step S2.2

Step S2.1 is preferably never interrupted, but it is dependent on the reconstructability table RT and on further system configuration settings, which can be modified when a new iteration of the entire Phase P1 takes place, triggered in Step S2.2.

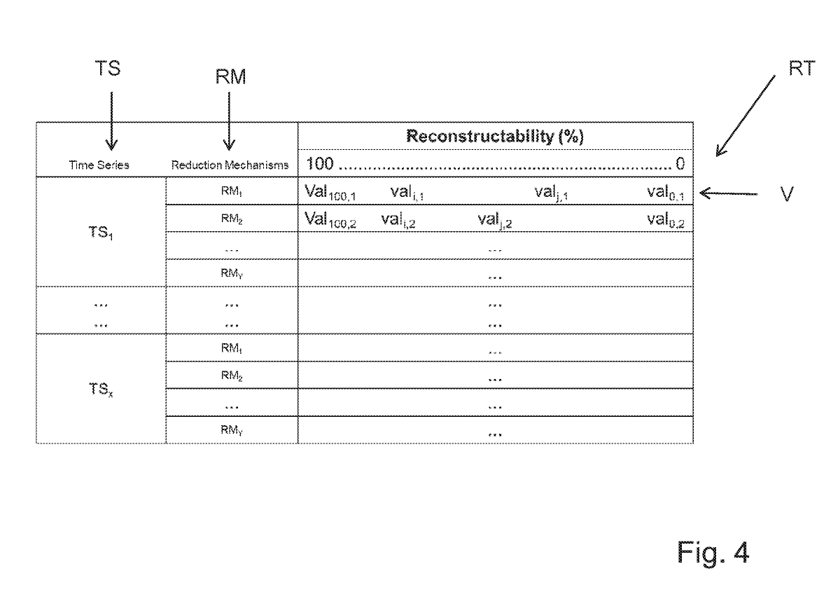

FIG. 4 shows a part of a system according to a third embodiment of the present invention. In FIG. 4 a visualization of the reconstructability table RT is shown. The following is assumed:
The existence of X incoming Time Series, e.g., collected/reported from sensors, cameras, smartphones etc. The set of Time Series is defined as TS:=(TS₁, TS₂, . . . , TS_{X})
The existence of Y data reduction procedures, e.g., “sampling”, “selective filtering”, “compression”. The set of data reduction procedures is defined as RM:=(RM₁, RM₂, . . . , RM_{Y}).
The existence of n_{K} applicable values for RM_{K}. The set of applicable values for RM_{K} is defined as V_{K}:=(val₀,_{K}, val₁,_{K}, . . . , val_{(nK-2)},_{K}, val₁₀₀,_{K}), whereby val₀,_{K} is the value for which no data at all is forwarded In this case the reconstructability degree is defined to be equal to 0%, although a “random reconstruction” could give values that have a similarity >0 with the original data set and val₁₀₀,_{K} is the value for which the reconstructability degree is equal to 100%, while the rest of the values lead to reconstructability degrees between 0% and 100% (including 0 and 100).

Then, the reconstructability table RT is computed as follows: For each triple (t, r, v) where t ∈ TS, r ∈ RM, and v ∈ V₁ ∪ V₂ ∪ . . . ∪ V_{Y}, i.e., for each combination of a time series with a data reduction procedure and a value of this data reduction procedure the reconstructability degree p of the triple is measured. The computation of ρ can be based, for example, on the Euclidean distance between the vector of the original data and the vector of the reconstructed data. Similarly, the reconstruction might be performed with linear interpolation or any similar method. ρ is calculated as the degree to which the data of time series t that was collected during period T1 can be reconstructed after it has been reduced with method r using the value v.

FIG. 5 shows a part of a method according to a fourth embodiment of the present invention. In FIG. 5 a data reduction and reconstruction with various applicable values of two reduction methods, i.e. dimensional reduction reduction and function-based representation is shown. In FIG. 5 an original time series O-TS also named TS₁ with a plurality of values V is incoming during the period T1. For example the values V can be smart meter values measured over time.

Further two reduction procedures will be used:
RM₁: Dimensionality reduction (i.e., sampling of each, every second, every fourth, or no data point of TS₁). Thus, V₁:=(0:∞, 1:4, 1:2, 1:1).
RM₂: Function-based representation, i.e., forwarding to the Cloud only a function, which represents the data “as good as possible”. Here it is assumed that two such functions come into question for TS₁, namely f(x) and g(x). Thus, V₂:=(0:∞, f(x), g(x), TS₁-func) whereby 0:∞ forwards nothing to the Cloud, while “TS₁-function” is defined as the function that gives exactly all the data points of TS₁. The latter is, of course, not always possible in reality, and even if it is, it might require a representation that is similar to or bigger than the full representation of the actual data.

Thus, the middle row of graphs of FIG. 5 shows the reduced (circular) and the reconstructable (triangle) data points of TS₁ when RM₁ is applied with its four different applicable values, while the lower row of graphs of FIG. 5 shows the data that is forwarded when RM₂ is applied with its four different applicable values.

Now, the Calibrator C:
calculates a reconstructed version of TS1 (partly shown in FIG. 5) for each of the eight cases of reduced data (middle and lower row of FIG. 5),
compares each reconstructed version with the original data set (upper graph of FIG. 5) based on a similarity metric, e.g., Euclidean distance, thus computing the so-called reconstructability degree or level and
writes the computed reconstructability degree into the reconstructability table RT.

In this example, it is assumed that the computed reconstructability degrees for 1:2-dimensionality-reduction and 1:4-dimensionality-reduction were 95% and 55%, respectively, while the reconstructability degrees for f(x) and g(x) were 80% and 70%, respectively:
ρ(val₀,₁)=0
ρ(val₁,₁)=55
ρ(va1₂,₁)=95
ρ(val₁₀₀,₁)=100
ρ(val₀,₂)=0
ρ(val₁,₂)=80
ρ(va1₂,₂)=70
ρ(val₁₀₀,₂)=100.

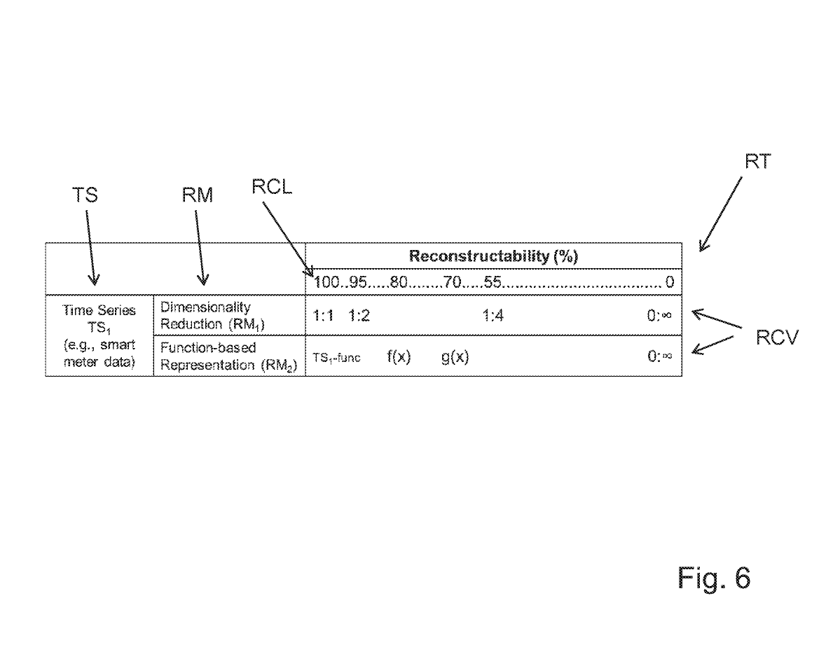

FIG. 6 shows a part of a system according to a fifth embodiment of the present invention. In FIG. 6 an example instance of a reconstructability table RT is shown based on the values of FIG. 5. With a time series TS the corresponding reduction mechanism RM and the reconstructability level RCL corresponding to reconstruction values RCV of the corresponding reduction mechanism RM.

In summary the present invention enables determination which data to forward, which to filter and which to cache based on the reconstructability of time series data points. Further the present invention enables using time series compression procedures or techniques before the time series are actually collected upon a frontend samples. The present invention further enables to apply a phase-change procedure based on an analysis of data streams comprising a calibration phase/operation phase and to trigger by the main specific events captures with the local data analytics.

The present invention preferably provides a method for filtering and forwarding of time series data in an internet-of-things environment based on data-reconstructability metrics comprising the steps of:
1) Reception of a required reconstructability degree from the backend to the network edge devices.
2) Triggering of the calculation of reconstructability characteristics of the incoming data upon local samples at the network edge (gateway) and choosing a data reduction mechanism based on these and the backend requirement.
3) Mode-based operation of the gateway which forwards, caches, or filters incoming data points to the backend system based on the previously chosen mechanism.

Embodiments of the present invention may have inter alia the following advantages: Embodiments of the present invention may enhance the efficiency in terms of storage, bandwidth and average data quality, preferably in an internet-of-thing system simultaneously maintaining the desired level for the reconstructability of the original data from the subset that has been stored in a data center.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for filtering data series prior to further processing, wherein the data series are collected by collecting entities and provided to one or more filtering entities from one or more data delivering devices, and wherein the filtered data series are forwarded to further processing entities, the method comprising:
filtering, by the filtering entities, the data series by the following steps:
a) collecting a data series including original information,
b) reducing the original information of the data series based on and by at least one data reduction procedure to produce at least one set of reduced information of the data series,
c) reconstructing the original information for the at least one set of reduced information of the data series,
d) calculating a level of reconstruction for the reconstructed information based on a comparison between the reconstructed information and the original information collected in step a) for the at least one data reduction procedures, and
e) determining reduced or non-reduced information of the data series to be forwarded based on a comparison between a desired level of reconstruction and the calculated level of reconstruction.

2. The method according to claim 1, wherein at least steps a)-d) are performed in irregular and/or regular time intervals, upon prespecified changes and/or appearance of prespecified values in data series.

3. The method according to claim 1, wherein when collecting the data series the highest possible polling rate and/or the highest possible resolution is used.

4. The method according to claim 1, wherein a reconstructability information is generated specifying for the data series and for each reduction procedure and for corresponding input values for the reduction procedures a value for the level of reconstruction.

5. The method according to claim 4, wherein the reconstructability information are updated when steps a)-d) are performed

6. The method according to claim 1, wherein a reduction procedure is provided in form of a procedure reducing dimensionality and/or size of the data series and/or a generation of a function representing the data series.

7. The method according to claim 1, wherein the comparison according to step d) is performed on a similarity metric using a Euclidian distance.

8. The method according to claim 1, wherein the collecting entities are configured based on an operational status of the filtering entities.

9. The method according to claim 8, wherein when the operational status of the filtering entities is dedicated for energy saving, then the collecting entities are reconfigured such that only reduced information satisfying the desired level of reconstruction is collected.

10. The method according to claim 8, wherein when the operational status of the filtering entities is dedicated for network resource saving, then the collecting entities are reconfigured such that only reduced information satisfying the desired level of reconstruction are forwarded and the collected information is cached in a filtering entity and/or in a collecting entity.

11. The method according to claim 10, wherein when the operational status of the filtering entities is dedicated for network resource saving, the collected information is forwarded upon demand of the further processing entities, in regular time intervals and/or never.

12. A system for filtering data series prior to further processing, the system comprising:
one or more data delivering devices adapted to provide data series, and
one or more collecting entities adapted to collect the data series and to provide them to one or more filtering entities, and
wherein the one or more filtering entities are adapted to forward the filtered data series to further processing entities,
wherein the one or more filtering entities are adapted to perform the following steps:
a) collecting a data series,
b) reducing the information of the data series based on and by at least one data reduction procedure to produce at least one set of reduced information of the data series,
c) reconstructing the original information for the at least one set of reduced information of the data series,
d) calculating a level of reconstruction for the reconstructed information based on a comparison between the reconstructed information and the original information collected in step a) for at least one of the reduction procedures, and
e) determining reduced or non-reduced information of the data series to be forwarded based on a comparison between a desired level and a calculated level of reconstruction.
